(19) United States
(12) Patent Application Publication
(10) Pub. No.: US 2006/0085441 A1
(43) Pub. Date: Apr. 20, 2006

(54) Method and apparatus for download and storage of content

(76) Inventors: James M. Funk, Menlo Park, CA (US); Steve Shannon, Hillsborough, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/968,227

(22) Filed: Oct. 18, 2004

(51) Int. Cl. G06F 7/00

(52) U.S. Cl. 707/100

(57) ABSTRACT

Multimedia content, including user requested programs, advertisements, electronic program guide and other content deemed to be of interest to a user to a client device is downloaded and stored on a client device on the basis of storage space availability for logical group(s) to which the content belongs. Such content may be speculatively downloaded and an indication of immediate availability for viewing provided to the user.

### BACKGROUND OF THE INVENTION

1. Field of Invention

The invention relates generally to the fields of video on demand (VOD) and storage of multimedia content. More specifically, the invention relates to storing an audio/video program on a storage medium (e.g., a hard drive) by checking the availability of storage space within a logical partition of the storage medium available to the program, based on certain properties associated with the program.

2. Description of Related Technology

Download and View Video-On-Demand

VOD generally refers to a personalized viewing service offered by a content provider or a network operator over a network to a content viewer. The viewer is typically able to start a VOD session by electronically browsing through a catalog of available content, selecting a program for viewing and receiving the selected content for viewing via a content device over the network.

With the recent advances in computing, signal processing and telecommunications technologies, the ability to download and watch audio/video content over a network connection is opening up new opportunities to deploy VOD services. In a download-and-view VOD service, users can access content over the Internet, download it to a local storage device and view the content at a later time.

Local Storage of VOD Content

When a client device with local storage capability is used in a download-and-view VOD system, over a period of time multiple program titles will be downloaded, stored, viewed and deleted from the local storage medium. Conventional techniques exist in the computer industry to efficiently manage storage space utilization on a computer where multiple files are written to or deleted from the storage medium. The conventional art also offers software tools to the users of such system to manually organize files on the computer hard drive. Similar facilities are not, however, readily available for entertainment applications such as a VOD client device with local storage, wherein a user may not want to, or may not have the skills to, manage disk space. Similarly, large-sized files may be downloaded automatically to such a device, thereby offering no opportunity for a user to intervene and create space for such downloads, if needed.

The download and view VOD model also presents some unique challenges not necessarily associated with conventional storage schemes. For example, not all content being added to (or removed from) a local storage medium is likely to be of equal importance to the user. A user may well notice and complain if a high value program cannot be downloaded to the client device due to space unavailability, when in fact the storage medium is filled with content that the user has little or no interest in watching. Moreover, because users' viewing habits could (and likely will) change over a period of time, rules for caching content implemented by such a system should be easily modifiable. Finally, because in a typical deployment of a VOD client device it may (and likely will) be used by multiple users (e.g., different members of a family) with different priorities and content access levels, such a caching scheme should also take into account intricacies associated therewith.

Based on the foregoing, it will be evident that while the prior art has in general recognized the utility of multimedia file caching and disk space management, it lacks a method to adequately address many of the requirements and intricacies associated with deploying and using such caching schemes in the field of download-and-view VOD.

### SUMMARY OF THE INVENTION

The present inventors have recognized that a scheme for managing local storage space on a VOD client device in which a storage manager and a download manager communicate with each other when adding content to or removing content from the storage medium is needed. To address the issues associated with viewer (and/or service provider) priorities, the present inventors have recognized that a system to manage storage space on a VOD client device should preferably implement a mechanism to differentiate content based on its value to the user (and/or to the VOD service provider) as indicated by certain parameters associated with each program and make storage space available as a function of that priority. Such a storage scheme should also preferably be transparent to users in general, but also flexible enough to allow some disk space control or management opportunities for more sophisticated users. To address variations in viewing habits the caching rules associated with the present system are modifiable, and, furthermore, the ability to speculatively cache content to the client device ahead of any user instructions to do so is also provided. The present system is also configured to allow for management of situations where multimedia content could belong to multiple logical groups. The present invention thus provides, in various embodiments, a method and apparatus for caching multimedia content locally, such caching based on organization of the local storage space in logical cache slots, and monitoring available space for a new program being downloaded by checking for, and if needed making available, space for its priority level.

In a first aspect of the invention, a method for organizing downloads of one or more multimedia files from one or more Internet hosts according to user priority and host availability criteria is disclosed. This method includes automatically storing the multimedia files according to categories thereof on portions of a computer-readable medium segregated according to said categories. In one embodiment, said categories include one or more of: subscription-based content, genre, rating, user profile, number of programs, and type. In some cases, the portions of the computer-readable medium may be logically segregated according to user preference and/or at least one of the portions of the computer-readable medium may be allocated for storing pay-per-view content.

In various ones of the above-described implementations, the one or more of the multimedia files may be speculatively downloaded according to one or more of: a user profile, user preferences, or content management agreements between a provider of the one or more multimedia files and an organization promoting availability thereof If necessary or desired, existing content stored on the computer-readable medium may be deleted on a portion-by-portion basis to accommodate downloads of the multimedia files.

In yet another aspect of the invention, a process for speculatively downloading, in the absence of a user instruction to do so and to a set-top appliance having a computer-readable medium segmented to include storage space for one or more multimedia files subject to a content management agreement between a provider of the one or more multimedia files and an organization promoting availability thereof, at least one of the multimedia files is provided.

In still another aspect of the invention, a set-top appliance includes a content management application configured to download one or more multimedia files from one or more Internet hosts according to user priority and host availability criteria, and a computer-readable medium configured to store the one or more multimedia files within segregated sections thereof, the sections of the computer-readable medium having been segregated according to categories of the multimedia files.

### BRIEF DESCRIPTION OF THE DRAWINGS

The above and other features and advantages of the present invention are hereinafter described in the following detailed description of illustrative embodiments to be read in conjunction with the accompanying drawings, wherein like reference numerals are used to identify the same or similar system parts and/or method steps, and in which:

FIG. 1 is a functional block diagram illustrating an exemplary IP network configuration useful with the present invention.

FIG. 2 shows high level stages of the lifecycle of multimedia content on a client device, according to an embodiment of the present invention.

FIG. 3 illustrates signals exchanged among various processes running on a client device to manage download, storage and viewing of multimedia content according to an embodiment of the present invention.

FIG. 4 illustrates steps of an exemplary algorithm implemented by a client device for storage of downloaded content, in accordance with an embodiment of the present invention.

### DETAILED DESCRIPTION

Reference is now made to the drawings wherein like numerals refer to like parts throughout. Described herein is a method and apparatus to store content files on a client device.

As used herein, the terms “content” and “program” are used substantially similarly and refer to audio, video, graphics files (in uncompressed or compressed format), icons, software, text files and scripts, data, binary files and other computer-usable data used to operate a client device and produce desired audio-visual effects on a client device for the viewer.

As used herein, the term “VOD” is meant to include on-demand delivery of content.

As used herein, the term “client device” is meant to include any manner of computer-based equipment capable of being communicatively coupled to one or more content sources (e.g., via the Internet and an applicable communication device such as a modem) to download multimedia content to a local computer-readable medium for later playback through a display device. The display device may, but need not, be integral to the client device. Often, the client device will be a set-top box.

As used herein, the term “content provider” refers to a person or business entity that makes multimedia content available to the users of a VOD service. No particular assumptions about a business relationship between the content provider and the VOD service provider are critical to the present invention. Content providers may, in some instances, be large commercial enterprises such as movie studios, television broadcasters and the like. In other cases, the content providers may be individuals, small businesses, independent movie producers and so on. Thus, the term content provider is used generally to describe any person or entity that wishes to make content (and particularly audio-video content) available to others. Often, though not necessarily, the content will be made available for a fee.

As used herein, the term “VOD service provider” refers to a commercial entity that provides an end user a VOD service including the ability to browse through available program titles, download content of interest and view it. As was the case for the content provider, the VOD service provider can be any form of entity or an individual. In general, the VOD service provider need not be a network facilitator. For example, where the Internet is used as the distribution channel for the content, the VOD service provider need not be an Internet service provider, network operator or associated with any form of network infrastructure provision. Instead, the VOD service provider may operate one or more Internet hosts configured to provide the program guide described below and to facilitate the distribution of metadata regarding content available for download to end users thereof. Often, though not necessarily, the VOD service provider will operate Internet hosts from which the content is available for download, however, this is not critical to the present invention. The VOD service may make use of special or general purpose computer systems configured to download and display the Internet content using any of a variety of communication and presentation applications. The precise nature of such application programs and, indeed, the nature of the computer systems on which the content is played back is not critical to the present inventions except insofar as the discussion below indicates.

In view of the above, it should be appreciated that some portions of the detailed description that follows are presented in terms of algorithms and symbolic representations of operations on data within a computer memory. These algorithmic descriptions and representations are the means used by those skilled in the computer science arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like. It should be borne in mind, however, that all of these and similar terms are to be associated with the appropriate physical quantities and are merely convenient labels applied to these quantities. Unless specifically stated otherwise, it will be appreciated that throughout the description of the present invention, use of terms such as “processing”, “computing”, “calculating”, “determining”, “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention can be implemented with an apparatus to perform the operations described herein. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and processes presented herein are not inherently related to any particular computer or other apparatus. Various general-purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor or by any combination of hardware and software. One of ordinary skill in the art will immediately appreciate that the invention can be practiced with computer system configurations other than those described below, including hand-held devices, multiprocessor systems, microprocessor-based or programmable consumer electronics, DSP devices, network PCs, minicomputers, mainframe computers, and the like. The invention can also be practiced in distributed computing environments where tasks are performed by remote processing devices that are linked through a communications network. The required structure for a variety of these systems will appear from the description below.

The methods of the present invention may be implemented using computer software. If written in a programming language conforming to a recognized standard, sequences of instructions designed to implement the methods can be compiled for execution on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, application, etc.), as taking an action or causing a result. Such expressions are merely a shorthand way of saying that execution of the software by a computer causes the processor of the computer to perform an action or produce a result.

Overview

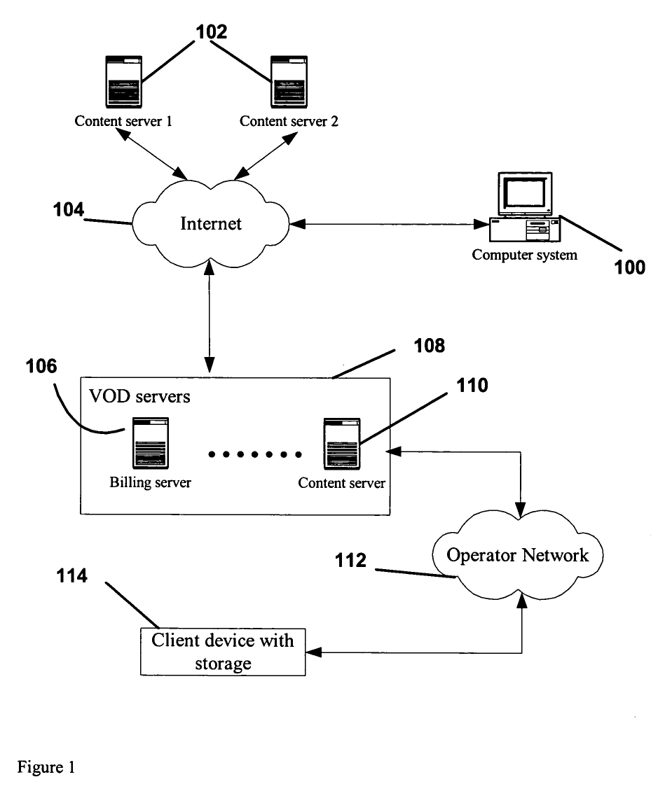

FIG. 1 shows a block diagram of an exemplary computer network in which the present invention can be implemented. The figure shows a computer system 100, content servers 102 and a group of VOD servers (shown as box 108), all communicatively coupled to each other via a network 104. The group of VOD servers consists of server(s) that perform functions such as billing and account management (106) and hosting of VOD content and a program guide (110). These VOD servers are communicatively coupled with a VOD client device 114, via an Internet service provider's operator network 112. This network diagram represents typical Internet connectivity available to residential users, but is not intended to limit the present invention. In practical situations, some variations to this network configuration are possible. For example, in the case when a user browses the Internet using a home computer, the computer system 100 will also often be connected to the network 104 through the operator network.

Lifecycle of Multimedia Content on a Client Device

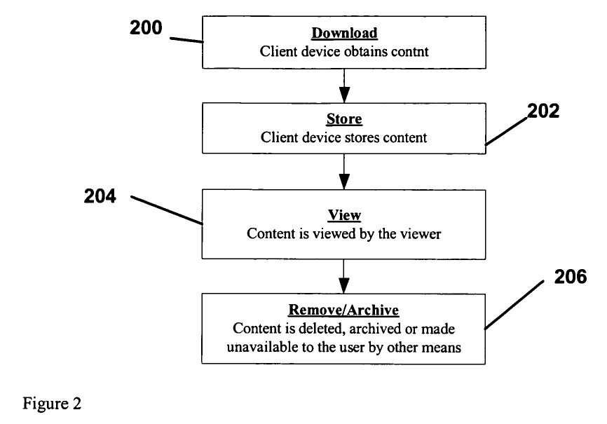

For fulfillment of a user's experience, content is downloaded to the client device 114, stored locally (e.g., on a hard drive) and displayed on a display device (e.g., a television or monitor) attached to the client device. FIG. 2 shows an example of the “lifecycle” of content on a client device within such a framework. These steps are described herein to illustrate the present invention and are not intended to limit the present invention. Implementers can choose to combine, skip or add to the steps described below and represented in this figure. As shown, content is downloaded to the client device in step 200. Such a download could be performed as a result of an explicit user command (e.g., a user key press while browsing a program guide) or an implicit user command (e.g., a previously scheduled request to download certain content at a given time or when it becomes available or when some other criteria is met) or by a VOD service provider “pushing” content to the client device (i.e., transmitting it to the client device without explicit user instructions to do so).

When the content download begins in step 200, the content needs to be stored on the client device's local storage medium (step 202). While the content is stored as a single logical multimedia title, no assumptions are made in the present invention of the physical distribution of the content data on the local storage medium. For example, the content may be located in multiple fragments on a hard drive, such fragments logically connected to each other through a pointer table or other means. Once the content is downloaded to the local storage medium, it is made available to and subsequently viewed by the user (step 204). In some implementations, the process of making content available to the user could involve explicit audio-visual indication. In one embodiment of the invention, such viewing of content may be offered only after the entire content file is downloaded (and a viewing license obtained, if needed). In another embodiment, content viewing may be possible before the entire download is finished, when enough content pieces have been downloaded. Similarly, step 204 may be omitted for some multimedia content. That is, the content may be downloaded to the local storage medium but may never be viewed by the user.

Whether or not the content is viewed by the user, at the end of the life cycle, most content will be either removed from the local storage medium, archived or made unavailable for viewing by the user (e.g., the viewing license may expire) as in step 206. In some cases, content might be marked to reside on the local storage medium for an indefinite period or until explicitly deleted by the user. Examples of such content include graphical icons, signature tune audio files, service providers' logos, etc.

### DESCRIPTION OF EXEMPLARY EMBODIMENTS

Exemplary embodiments of the method and apparatus of the present invention are now described in detail. To help explain the embodiments, three functional entities called managers are first described below.

Content Download Manager

The content download manager is responsible for downloading content from one or more locations on the network to the local storage medium (or mediums) of the client device. In some implementations, this manager may also perform prioritized execution of multiple outstanding download requests. In co-pending U.S. patent application Ser. No. 10/928,451 (Attorney Docket No. 7177P001) entitled “Method and apparatus for downloading content” filed Aug. 27, 2004, assigned to the assignee of the present invention and incorporated herein by reference, a download manager is described that is executed on a client device to prioritize and manage download tasks of multiple download requests. The content download manager in the referenced patent application uses a mechanism called the work list to prioritize downloads. Work items can be added to such a work list by other software modules, running either on the client device or elsewhere.

Content Storage Manager

This functional entity is responsible for storage and removal of content on the client device. This includes functions such as, without limitation, making space available for download of a new multimedia program, enforcing rules regarding type of content and storage space, reclaiming storage space back from deleted content, etc.

Content Viewing Manager

This functional entity receives a user's request to view a multimedia program, processes the request and forwards it to the download manager for downloading or to the content storage manager for playing out content from local storage to the user's display device through a signal format converter (e.g., an MPEG video decoder and subsequent NTSC television signal generator).

Download and Store

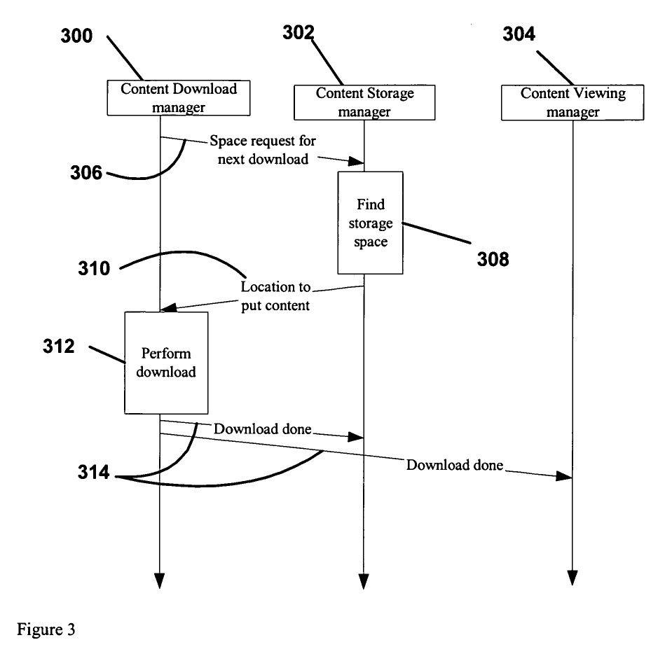

Referring to FIG. 3, when the client device is about to begin a content download, the content download manager 300 queries the content storage manager 302 for an indication of where the to-be-downloaded content should be stored (signal 306). Such an enquiry may contain details about the content that help the storage manager determine factors such as the priority associated with the content or the logical group to which the content belongs. In response, the content storage manager implements a process 308 to find space to store the content.

If the storage manager finds sufficient space for the content being downloaded (as is assumed in the flow of the figure), it so notifies the download manager and provides sufficient information for the download manager to know where to store the content (signal 310). Depending on the implementation, such information may be in the form of a pointer to or an address of one or more disk locations, the amount of storage space available at each location, and so on.

Knowing that sufficient storage space is available then, the download manager begins the download process (step 312). This process may be divided into multiple iterations in some implementations, with such location query/response signal exchanges (306, 310) performed between downloads of pieces of the multimedia content. When the download manager finishes the content download, it so notifies the storage manager (314).

The viewing manager (304) is also notified of the completion of the download. This, in turn, leads to a user of the client device being made aware of the availability of the content. Various embodiments of such a notification 314 exist, including the omission of any explicit notification, polling by the receiving manager to find out if the process is complete, and so on. It should be noted that the requester that triggered this download initially could have been the user, the VOD service provider or some other entity. Similarly, the content itself could be, without limitations, user requested pay-per-view content, content download from a subscription service, content download from a membership service, premium content trickled in and speculatively cached by the service provider, and/or house-keeping content such as software updates, program guide, graphical icon data, and so on.

Organization of Content in Cache Slots

Since local storage of content is controlled by a content storage manager, the VOD service provider can implement various rules regarding the amount of storage space that is made available to particular types of content. In this description of the present invention these segregated storage spaces on one or more physical mediums are referred to as “cache slots.” In practical implementations of VOD systems, over a period of time, many programs will be downloaded to a client device. To a user or a VOD service provider, the importance of availability of each such program title may be different. For example, ensuing successful download-and-storage of a pay-per-view program that generates revenue for a content provider and/or a VOD service provider may be more important to the provider as compared to a free-to-air, low ratings program as a part of a complementary subscription service.

It is also important to note that the amount of storage space required to cache a program may not be indicative of its importance to a user or a VOD service provider or a content provider. For example, a 2-hour long movie may not be as important to a viewer as a 2-minute-long sporting event or highlight, but may take up significantly more storage space than is required to store the sporting event program. In various embodiments of the present invention, the content storage manager may enforce caching rules by dividing the total available storage space into one ore more logical groups and store programs based on the space available to the logical groups to which the programs belong.

To illustrate this feature consider that a user may have subscribed to multiple content providers' programming. In such a case, cache slots might be organized so as to dedicate a fixed amount of storage capacity for each content provider's content (e.g., one content provider may be given 8 Gigabytes of storage space while another content provider may be given 20 Gigabytes of storage space on a user's client device). Such allocation of guaranteed storage space generates revenue opportunities for the VOD service provider by, for example, sharing a higher percent of a favored content provider's revenue. This content segregation also ensures that large-sized program downloads from one content provider will not create storage space starvation for downloads of content from another content provider.

It will be readily apparent to the skilled practitioner that many possibilities exist to logically divide the local storage in cache slots assigned to logical groups. Some examples of factors that may be considered in organizing such cache slots include, without limitation, program genre, convent advisory rating, type (audio, video), resolution, advertisements (e.g., the presence or absence thereof in other content or simply separate space for such advertisements themselves), news, number of programs present in the cache slot, how long the programs have been cached for, any ongoing special promotions, expiration of viewing authorization, and so on. Such rules can be enforced and changed as needed using conventional techniques such as look up tables, file-based rules, downloading of a new content storage manager module, and so on.

Sharing Storage Among Cache Slots

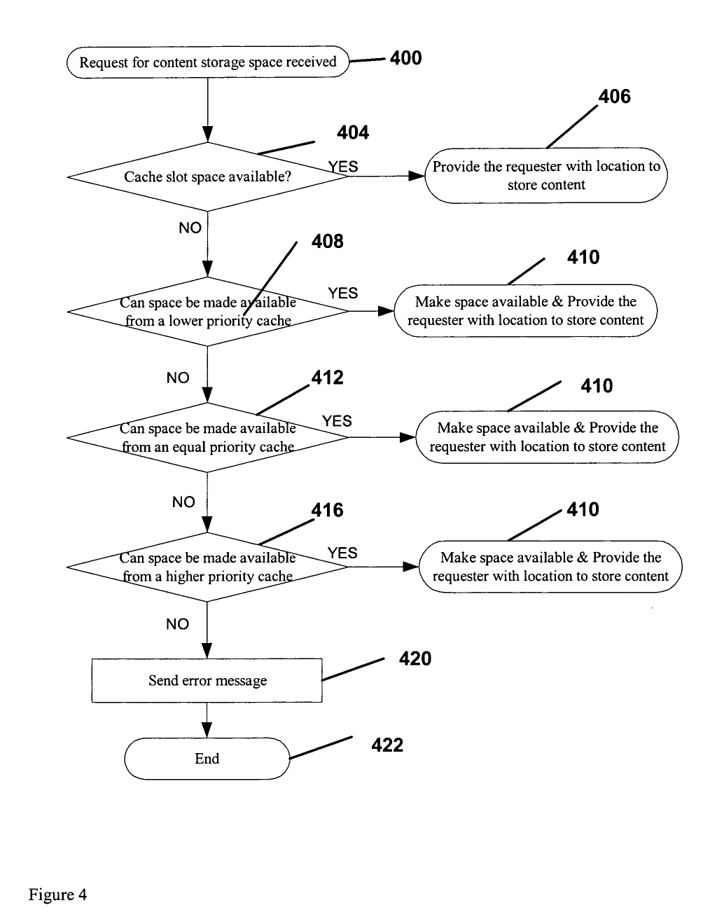

In some implementations, the storage rules as described herein may be imposed on a cache slot independently of the storage situations of other cache slots. That is, size limits may be enforced even if other cache slots are not full. In another implementation, higher priority cache slots may be able to reclaim some cache space from lower priority cache slots. For example, as shown in FIG. 4, when the content storage manager receives a content storage request in step 400, the manager checks to see if enough space is available for the cache slot corresponding to the program desired to be downloaded (404). If enough space is available, the requester is given an affirmative response and an indication of where to store the content (406). If however, sufficient storage space is not available in the corresponding cache slot, the storage manager may check to see if it can use storage space of a lower priority cache slot (408).

In some embodiments, the content manager may take into account an additional level of grouping wherein a given program may have multiple priorities to multiple users of the client device, each user himself/herself having a different priority. Therefore, when candidate programs are chosen for deletion to make space for a new program download, the priority of such programs is compared with the priority of the new program in the context of the profile of the user for whom the program is being downloaded. If such space is available, it is allocated to the program to be downloaded and the requester notified with an affirmative response indicating where to store the content (410).

In some implementations, if no storage space is available in any of the lower priority cache slots, the content manager may then check to see if space is available in any other cache slots of equal priority (412). If space is available, the requester is notified as in step 410 above. In some implementations, similar space reclamation may be attempted from higher priority cache slots (step 416), with the understanding that a higher priority cache slot request may pre-empt the current request.

Step 410 is repeated in case space is available or an error message indicating storage space unavailability is communicated back to the requester (420) if no space is available. The content storage manager may try to create space by performing a clean-up or may wait for the requester to react to the error message.

Speculative Caching

Based on the information available to a VOD service provider regarding a user's downloading and/or viewing habits, the service provider may want to send content to the user's client device in anticipation of the user wanting to view it in future. Depending on the importance of such speculative caching to a user's service experience, the content storage manager may allocate proportionate cache slot space to content speculatively cached. Once such content is cached, the content viewing manager is made aware of the availability of the content. The viewing manager can then provider a user an audio/visual signal (e.g., a “available now” or “just downloaded” program guide screen) to indicate availability of such content.

In some implementations, speculative caching can also be initiated by an agent executed on the client device, designed to monitor user viewing habits. Both such an agent and/or the service provider can use a mechanism such as the work list described in the above-referenced patent application to indicate to the download manager the desire to download the content. User control of cache slots

Some embodiments of the present invention may keep the details of cache slots and local storage management invisible and inaccessible to a user. Other embodiments may expose some or all of these caching details for a user to view and control. For example, in one embodiment, a user may be given the option to set up relative or absolute sizes of caches for certain logical program groups (e.g., space allocated for a parent's program selections and a child's program selections). In another embodiment, a user may select programs to delete or preserve, such selection intended to either help a content storage manager make decisions, or override a content storage manger's decisions.

In the foregoing specification, the invention has been described with reference to specific exemplary embodiments thereof. It will, however, be evident to those of ordinary skill in the art that various modifications and changes may be made thereto without departing from the broader spirit and scope of the invention as set forth in the appended claims. The specification and drawings are, accordingly, to be regarded in an illustrative rather than a restrictive sense and it should be understood that the following claims including all equivalents are intended to define the scope of the invention.

What is claimed is:

1. A method, comprising organizing download of one or more multimedia files from one or more Internet hosts according to user priority and host availability criteria, and automatically storing the multimedia files according to categories thereof on portions of a computer-readable medium segregated according to said categories.

2. The method of claim 1, wherein said categories include one or more of: subscription-based content, genre, rating, user profile, number of programs, and type.

3. The method of claim 1, wherein the portions of the computer-readable medium are logically segregated according to user preference.

4. The method of claim 1, wherein at least one of the portions of the computer-readable medium is allocated for storing pay-per-view content.

5. The method of claim 1, wherein one or more of the multimedia files is speculatively downloaded and stored on one of the portions of the computer-readable medium.

6. The method of claim 5, wherein the one or more of the multimedia files is speculatively downloaded according to one or more of; user profile, user preferences, or content management agreements between a provider of the one or more multimedia files and an organization promoting availability thereof.

7. The method of claim 1, further comprising deleting existing content stored on the computer-readable medium on a portion-by-portion basis to accommodate downloads of the one or more multimedia files.

8. The method of claim 1, wherein the portions of the computer-readable medium are logically segregated according to one or more instructions received from a remote Internet host.

9. A method, comprising speculatively downloading, in the absence of a user instruction to do so and to a set-top appliance having a computer-readable medium segmented to include storage space for one or more multimedia files subject to a content management agreement between a provider of the one or more multimedia files and an organization promoting availability thereof, at least one of the multimedia files.

10. The method of claim 9, wherein the at least one of the multimedia files is stored within the segmented storage space on the computer-readable medium.

11. A set-top appliance comprising a content management application configured to download one or more multimedia files from one or more Internet hosts according to user priority and host availability criteria, and a computer-readable medium configured to store the one or more multimedia files within segregated sections thereof, the sections of the computer-readable medium having been segregated according to categories of the multimedia files.

12. The set-top appliance of claim 11, wherein the categories include one or more of: subscription-based content, genre, rating, user profile, and type.

13. The set-top appliance of claim 11, wherein the sections of the computer-readable medium are logically segregated according to one or more of: user preference, amount of storage space, or number of programs.

14. The set-top appliance of claim 13, wherein the content management application is further configured to separately manage deletions of previously stored content from each section of the computer-readable medium to accommodate downloads of the one or more multimedia files.

15. The set-top appliance of claim 13, wherein at least one of the sections of the computer-readable medium is allocated for storing pay-per-view content.

16. The set-top appliance of claim 13, wherein the content management application is further configured to speculatively download Internet content according to one or more criteria and to store such speculatively downloaded content in at least one of the sections of the computer-readable medium allocated for such purpose.

17. The set-top appliance of claim 16, wherein the one or more criteria include: user preference, user profile and content management agreements between a content provider and an organization promoting availability thereof.

18. The set-top appliance of claim 11, wherein the sections of the computer-readable medium are logically segregated in response to one or more instructions received from a remote Internet host.

19. The set-top appliance of claim 18, wherein the sections of the computer-readable medium are logically segregated to accommodate speculative downloading of Internet content.

20. The set-top appliance of claim 19, wherein the speculative downloading of Internet content is performed according to one or more of: user preference, user profile or content management agreements between a content provider and an organization promoting availability thereof
